(19) United States
(12) Patent Application Publication
(10) Pub. No.: US 2025/0239093 A1
(43) Pub. Date: Jul. 24, 2025

(54) SEMANTIC PROMPT LEARNING FOR WEAKLY-SUPERVISED SEMANTIC SEGMENTATION

(71) Applicant: NVIDIA Corporation, Santa Clara, CA (US)

(72) Inventors: Min-Hung Chen, Zhubei City (TW); Ci-Siang Lin, Taipei City (TW); Chien-Yi Wang, New Taipei City (TW); Yu-Chiang Wang, Taipei City (TW)

(21) Appl. No.: 18/802,939

(22) Filed: Aug. 13, 2024

Related U.S. Application Data
(60) Provisional application No. 63/622,441, filed on Jan. 18, 2024.

(51) Int. Cl. G06V 20/70; G06N 20/00; G06V 10/26; G06V 10/764; G06V 10/774; G06V 20/58

(52) U.S. Cl. CPC G06V 20/70; G06N 20/00; G06V 10/26; G06V 10/764; G06V 10/774; G06V 20/58

(57) ABSTRACT

Semantic segmentation generally refers to a machine learning process that associates a label or category with every pixel in an image. This can be used to recognize a collection of pixels that form distinct categories of objects, which may have applications in autonomous driving for example where the vehicle needs to identify other vehicles, pedestrians, traffic signs, pavement, and other road features from captured images of a surrounding environment. While using pixel-level annotations may be ideal for fully-supervised training of the semantic segmentation model, collecting such annotations is time-consuming and expensive, and therefore limits the scalability and practicality of fully-supervised training methods. The present disclosure enables weakly supervised training of a semantic segmentation model aided by learned prompts embedded with semantic knowledge.

### RELATED APPLICATION(S)

This application claims the benefit of U.S. Provisional Application No. 63/622,441 (Attorney Docket No. NVIDP1392+/24-TP-0046US01), titled “SEMANTIC PROMPT LEARNING FOR WEAKLY-SUPERVISED SEMANTIC SEGMENTATION” and filed Jan. 18, 2024, the entire contents of which is incorporated herein by reference.

### TECHNICAL FIELD

The present disclosure relates to processes for generating object masks which can be used in weakly supervised semantic segmentation.

### BACKGROUND

Semantic segmentation generally refers to a machine learning process that associates a label or category with every pixel in an image. This can be used to recognize a collection of pixels that form distinct categories of objects, which may have applications in autonomous driving for example where the vehicle needs to identify other vehicles, pedestrians, traffic signs, pavement, and other road features from captured images of a surrounding environment.

While using pixel-level annotations may be ideal for fully-supervised training of the semantic segmentation model, collecting such annotations is time-consuming and expensive, and therefore limits the scalability and practicality of fully-supervised training methods. To address this issue, Weakly-Supervised Semantic Segmentation (WSSS) has emerged as an alternative approach to train segmentation models with only coarse or incomplete annotations that are more easily obtained if not even already available in existing benchmark image datasets. These annotations oftentimes include image-level labels which indicate the presence or absence of certain object categories. However, since precise annotations of object positions are not observed, learning to localize and segment object categories from image-level supervision is particularly challenging.

There is thus a need for addressing these issues and/or other issues associated with the prior art. For example, there is a need to learn prompts embedded with semantic knowledge discovered from a vision language model for use with weakly supervised training of a semantic segmentation model.

### SUMMARY

A method, computer readable medium, and system are disclosed for training a machine learning model to generate an object mask for a given image have an image-level label, including in an embodiment exploiting a pretrained vision-language model to guide weakly-supervised learning for segmentation. An input image having an image-level label that indicates one or more categories of objects included in the image is processed to generate a text prompt that indicates a target object category of an object included in the image. The machine learning model performs prompt contrastive learning using a foreground portion of the image, a background portion of the image, and the text prompt, to learn, for the target object category, a prompt embedded with semantic knowledge describing a background associated with the target object category. The machine learning model learns, from the prompt, to generate a foreground object mask for the target object category.

### BRIEF DESCRIPTION OF THE DRAWINGS

FIG. 1 illustrates a method for training a machine learning model to generate an object mask for a given image, in accordance with an embodiment.

FIG. 2 illustrates a method for using semantic prompt learning to train a machine learning model to generate an object mask for a given image, in accordance with an embodiment.

FIG. 3 illustrates a flow diagram of a framework employing the method 200 of FIG. 2, in accordance with an embodiment.

FIG. 4 illustrates a method for training a semantic segmentation model, in accordance with an embodiment.

FIG. 5 illustrates a method for generating an object mask for a downstream task, in accordance with an embodiment.

FIG. 6A illustrates inference and/or training logic, according to at least one embodiment.

FIG. 6B illustrates inference and/or training logic, according to at least one embodiment.

FIG. 7 illustrates training and deployment of a neural network, according to at least one embodiment.

FIG. 8 illustrates an example data center system, according to at least one embodiment.

### DETAILED DESCRIPTION

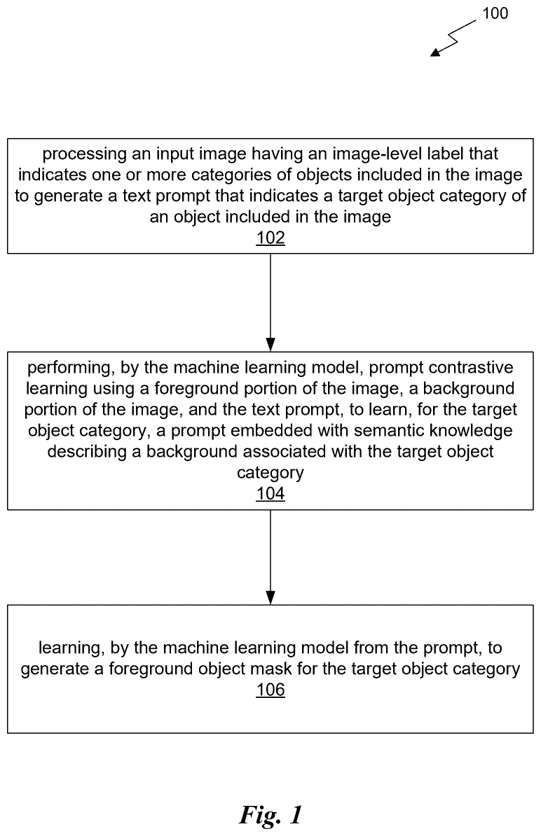

FIG. 1 illustrates a method 100 for training a machine learning model to generate an object mask for a given image, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

While the method 100 is performed to train a machine learning model, it should be noted that the machine learning model may be pretrained prior to performing the method 100. In this case, the method 100 may be performed to fine-tune, or further train, the machine learning model. In an embodiment, the machine learning model may be pretrained as a vision-language model. For example, the machine learning model may be pretrained on both images and texts to be able to generate an object mask for a given image based upon a given text that specifies a category of the object.

With respect to the present description, an object mask refers to a representation of a location in the image of one or more objects of the specified category. In an embodiment, the object mask may indicate portions (e.g. pixels) of the image that include one or more objects of the specified category. In an embodiment, the object mask may indicate for a plurality of portions (e.g. pixels) of the image whether each of such portions depicts a portion of an object of the specified category.

In operation 102 of the method 100, an input image having an image-level label that indicates one or more categories of objects included in the image is processed to generate a text prompt that indicates a target object category of an object included in the image. The image may be a two-dimensional (2D) image, in an embodiment. The image may be a three-dimensional (3D) image, in an embodiment. The image may be retrieved from an existing dataset of images having image-level labels.

The image-level label refers to a label (e.g. annotation) predefined for the image which indicates one or more categories of objects included in the image. Thus, while the image-level label indicates the categories of objects included in the image, the image-level label does not specify locations of such objects in the image. In an embodiment, the image-level label is a vector indicating a presence (or absence) in the image of a plurality of object categories.

The image is processed to generate a text prompt that indicates a target object category of an object included in the image. The text prompt refers to a text that the machine learning model is configured to be able to process as an input. In an embodiment, the text prompt may be generated using the image-level label defined for the image. For example, an object category indicated in the image-level label as having a presence in the image may be selected as a target object category for training the machine learning model. In an embodiment, the text prompt may be generated by inserting a name of the target object category into a text prompt template.

In operation 104, the machine learning model performs prompt contrastive learning using a foreground portion of the image, a background portion of the image, and the text prompt, to learn, for the target object category, a prompt embedded with semantic knowledge describing a background associated with the target object category. The foreground portion of the image refers to a portion of the image that, at least by estimate, includes one or more objects in the target object category. The background portion of the image refers to a portion of the image that, at least by estimate, does not include objects in the target object category. In an embodiment, the background portion of the image may depict a background scene or background object as opposed to a foreground scene in which the one or more objects in the target object category are located.

In an embodiment, the foreground portion of the image and the background portion of the image may be determined using an unrefined object mask predicted from the image for the target object category. In an embodiment, the machine learning model may predict the unrefined object mask from the image. In an embodiment, the unrefined object mask refers to an object mask predicted (e.g. estimated) by the pretrained machine learning model.

In an embodiment, the machine learning model may use image-text contrastive learning to predict from the image the unrefined object mask for the target object category. In the present description, contrastive learning refers to learning by contrasting positive and negative pairs of certain data instances. In an embodiment, the image-text contrastive learning may include computing from the image an initial object mask for the target object category, determining an initial foreground portion of the image based on the initial object mask, determining an initial background portion of the image based on the initial object mask, maximizing a similarity between the initial foreground portion of the image and the text prompt, and minimizing a similarity between the initial background portion of the image and the text prompt.

In an embodiment, the foreground portion of the image may be generated by applying the unrefined object mask to the image. In an embodiment, the background portion of the image may be generated by applying a reverse of the unrefined object mask to the image.

As mentioned above, the machine learning model performs prompt contrastive learning using the foreground portion of the image, the background portion of the image, and the text prompt, to learn, for the target object category, a prompt embedded with semantic knowledge describing a background associated with the target object category. The prompt may be in a format capable of being processed by the machine learning model. For example, the prompt may be a parameter of the machine learning model.

The prompt contrastive learning used by the machine learning model to learn the prompt for the target object category may include computing an initial (e.g. pseudo-random) prompt, determining a representation of the initial prompt in latent space, determining a representation of the background portion of the image in the latent space, determining a representation of the text prompt in the latent space, maximizing a similarity between the representation of the initial prompt and the representation of the background portion of the image, and minimizing a similarity between the representation of the initial prompt and the representation of the text prompt.

The learned prompt is embedded with semantic knowledge describing a background associated with the target object category. In an embodiment, the prompt may represent co-occurring backgrounds for the target object category. Co-occuring backgrounds refer to two or more portions of the image depicting different backgrounds (e.g. background scenes or background objects) to the one or more objects of the target object category.

In operation 106, the machine learning model learns, from the prompt, to generate a foreground object mask for the target object category. The foreground object mask refers to an object mask for the target object category which represents locations of objects in the image that are of the target object category. In an embodiment, the foreground object mask is a mask of an object in the target object category that is included in an image foreground. For example, the foreground object mask may indicate a location of the object in the image foreground.

In an embodiment, since the foreground object mask is learned from the prompt, the foreground object mask may be considered a refined object mask when compared with the unrefined object mask previously predicted for the image from the text prompt. In an embodiment, the machine learning model may learn to generate the foreground object mask by excluding semantic knowledge embedded in the prompt.

To this end, the method 100 operates to train the machine learning model to be able to generate an object mask for a given image. The object mask may be generated for the given image based on a specified object category (e.g. given via a text prompt). As described, this training is performed using a learned object category-specific prompt that embeds semantic knowledge describing a background associated with the category. By training from the prompt, the machine learning model learns to suppress any portions of the given image that are considered background to objects of a particular category when generating an object mask for that particular category. In an embodiment, the method 100 may be repeated for a plurality of different target object categories, in order to train the machine learning model with respect to the plurality of different target object categories.

Once trained in accordance with the method 100, the machine learning model may be output (e.g. provided, deployed, etc.). In an embodiment, the machine learning model may be output for use in generating an object mask for a given image. For example, the object mask may be generated for a selected object category indicated in the image-level label as being represented in the given image, or a separate object mask may be generated for each object category indicated in the image-level label as being represented in the given image. This particular use may form a dataset of images having image-level labels and associated object masks.

In an embodiment, the method 100 may be extended to include using the trained machine learning model to generate at least one object mask for at least one given image. In an embodiment, the method 100 may be extended to include providing the at least one object mask to a downstream task. The downstream task refers to any task that is configured to process an input object mask for a defined purpose.

In an embodiment, the downstream task may include training a semantic segmentation model using the dataset that includes the at least one object mask and the at least one given image have an image-level label. Using the object mask to train the semantic segmentation model may allow the semantic segmentation model to be trained with weak supervision (i.e. image-level labels versus pixel- or point-level labels) while improving an ability of the semantic segmentation model to accurately detect, locate and classify objects depicted in images. For example, the accuracy may be improved with respect to the model accurately suppressing background portions of an image when detecting, locating, and classifying objects depicted in images. This accuracy may in turn improve the functioning of an application that relies on such detected, located, and classified objects, such as an autonomous driving application that requires precise locations and classifications of objects to make autonomous driving decisions.

In another embodiment, the downstream task may include performing scene understanding using the object mask. The scene understanding may be required for some desired application. For example, the downstream task may include visual captioning, video understanding, visual question answering, etc.

Further embodiments will now be provided in the description of the subsequent figures. It should be noted that the embodiments disclosed herein with reference to the method 100 of FIG. 1 may apply to and/or be used in combination with any of the embodiments of the remaining figures below.

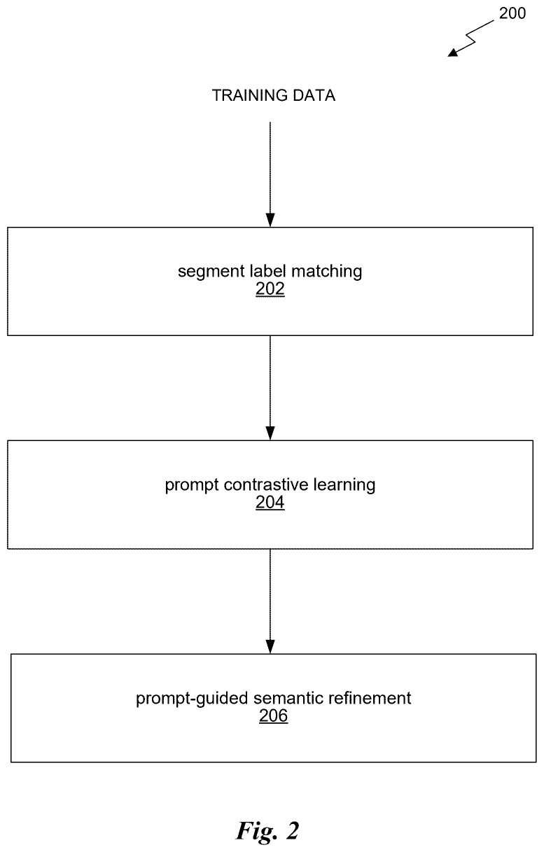

FIG. 2 illustrates a method 200 for using semantic prompt learning to train a machine learning model to generate an object mask for a given image, in accordance with an embodiment. The method 200 may be carried out in the context of the method 100 of FIG. 1, in an embodiment. Of course, however, the method 200 may be carried out in any desired context. The definitions and embodiments described above may equally apply to the description of the present embodiment.

As shown, segment label matching is performed in operation 202 for input training data. The input training data refers to images each having an image-level label indicating one or more categories of objects included in the image. The training data may be a publicly available data set of such labeled images. For example, the training data may include a set of N images X with the associated image-level labels y, where X∈ [symbol] ^{H×W×3} and y∈{0,1}^{K} is a multi-hot vector indicating the presence or absence of K object categories.

For the segment label matching, given an input image X, a mask generator S of a machine learning model is designed to produce soft foreground masks M=S (X) for target object categories. Since pixel-wise annotations are not available in the training data, a vision-language model is leveraged to guide the learning of the mask generator from image-level supervision. To be more precise, the joint latent space for images and texts from the vision-language model is exploited to match the object regions and the associated text labels.

To achieve this, an image-text triplet (i.e. foreground-background-text) is formulated to perform contrastive learning. For the kth ground truth category which presents in the input image X (i.e. yₖ=1), the foreground image Xₖ^{f}{=Mₖ·X is derived by applying the kth predicted mask Mₖ to the original image X. Similarly, the predicted mask is reversed to obtain the background regions Xₖ^{B}=(1−Mₖ). X. As for the text input tₖ, a prompt template “a photo of { }” filled with the kth class name in the brackets to describe the category of interest. With the triplet [Xₖ^{f}, Xₖ^{b}, tₖ] serving as the input of an image encoder Eₜ and text encoder Eₜ pre-trained as the vision-language model, image-text contrastive learning is performed to maximize the cosine similarity between Xₖ^{f} and tₖ for the foreground, while the similarity of Xₖ^{b} and tₖ is minimized to repel the background. Therefore, the matching loss L_{match} may be formulated per Equation 1.

$${L}_{match} = {𝔼}_{X} - [ log ( sim ( {v}_{k}^{f} , {u}_{k}^{f} ) ) + {λ}_{b} \cdot log ( 1 - sim ( {v}_{k}^{b} , {u}_{k}^{b} ) ) ] , where {v}_{k}^{f} = {E}_{I} ( {X}_{k}^{f} ) , {v}_{k}^{b} = {E}_{I} ( {X}_{k}^{b} ) and {u}_{k}^{f} = {E}_{T} ( {t}_{k} ) \qquad Equation 1$$

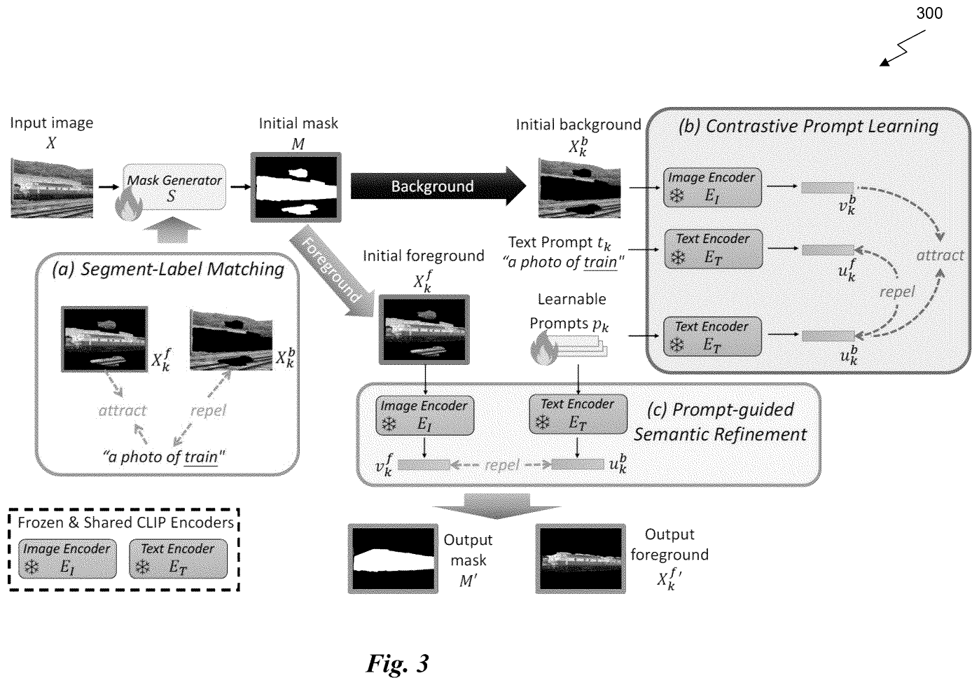

Here, λₚ is the loss weight for repelling backgrounds and sim refers to cosine similarity. Note that the image encoder Eₜ and the text encoder E_{T} are kept frozen during training and the latent space learned during pre-training is preserved to avoid potential overfitting. With the above segment-label matching, the mask generator S is encouraged to segment object regions that align with the associated text labels. However, such masks learned from image-level supervision are still coarse, and may falsely include co-occurring backgrounds associated with certain object categories. Therefore, the above image-text matching is not sufficient for segmentation and other applications. The segment label matching as described above is illustrated in step (a) of FIG. 3.

In operation 204, prompt contrastive learning is performed. To address the coarse mask issues mentioned above, prompt contrastive learning is used to learn prompts embedded with semantic knowledge from the vision-language model, facilitating a following object mask refinement. A sequence of learnable prompts pₖ is employed as the input of the text encoder Eₜ to describe backgrounds for each distinct category k. Specifically, to align the prompts pₖ with the background image Xₖ^{b}, the similarity of their representations in the latent space is maximized by proposing Lₚᵣₒₘₚₜ^{I}. On the other hand, to avoid describing the foreground objects, the similarity between uₖ^{b} and uₖ^{f} is encouraged to be low with the proposed Lₚᵣₒₘₚₜ^{T}. Lₚᵣₒₘₚₜ is illustrated per Equation 2.

$${L}_{prompt} = {L}_{prompt}^{I} + {λ}_{t} \cdot {L}_{prompt}^{T} = {𝔼}_{X} - [ log ( sim ( {u}_{k}^{b} , {v}_{k}^{b} ) ) + {λ}_{T} \cdot log ( sim ( {u}_{k}^{b} , {u}_{k}^{f} ) ) ] , where {u}_{k}^{b} = {E}_{T} ( {p}_{k} ) , {v}_{k}^{b} = {E}_{I} ( {X}_{k}^{b} ) and {u}_{k}^{f} = {E}_{T} ( {t}_{k} ) \qquad Equation 2$$

Here, the mask generator S is fixed and pₖ is the only trainable part for loss Lₚᵣₒₘₚₜ, and λ_{T} is the loss weight for minimizing the similarities to the object categories. Once the above learning is complete, the prompts pₖ would represent co-occurring backgrounds for each category k without requiring manually defined background prompts. In addition, the contrastive prompt learning aims to capture class-associated backgrounds which may be used for segmentation purposes, rather than replacing general text templates like “a photo of { }” for classification tasks. The prompt contrastive learning as described above is illustrated in step (b) of FIG. 3.

In operation 206, prompt-guided semantic refinement is performed. To suppress co-occurring background regions from the object mask M, the previously derived background prompts pₖ are exploited to perform prompt-guided semantic refinement. More specifically, the mask generator S is encouraged to produce refined masks M′ by excluding the semantic knowledge embedded in the background prompts pₖ, while the objectives introduced in Equation 1 are retained to match the class labels. Hence, the refinement loss L_{refine} and the total loss function Lₜₒₜₐₗ are defined per Equation 3.

$${L}_{total} = {L}_{match} + λ \cdot {L}_{refine} , where {L}_{refine} = {𝔼}_{X} [ - log ( 1 - sim ( {v}_{k}^{f} , {u}_{k}^{b} ) ) ] . \qquad Equation 3$$

Here, λ is the weight for the refinement loss. It can be seen that, with the derived background prompts pₖ (fixed here) and the introduced refinement loss L_{refine}, the class-associated background regions would be suppressed from the foreground mask M, preventing possible false activation. More importantly, by jointly applying the matching and refinement objectives with image-level supervision, vision-language learning is advanced to enhance the semantic alignment between the segmented regions and the target object categories, resulting in compact and complete object masks M′, which may then be used for segmentation.

It is worth noting that, the vision-language model and the learned prompts pₖ are leveraged to guide the learning of the mask generator S, and hence only the mask generator S is needed for producing object masks M′, including in a weakly-supervised semantic segmentation pipeline when the training is complete. The prompt-guided semantic refinement as described above is illustrated in step (c) of FIG. 3.

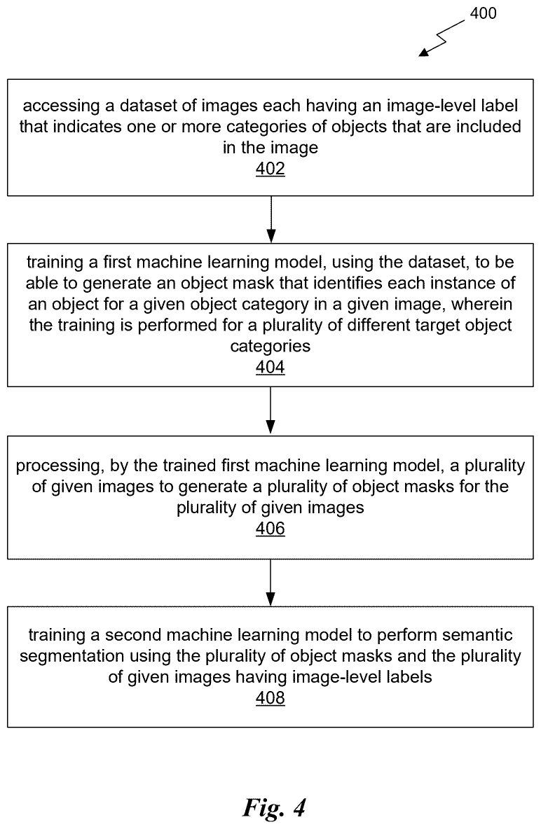

FIG. 4 illustrates a method 400 for training a semantic segmentation model, in accordance with an embodiment.

In operation 402, a dataset of images each having an image-level label that indicates one or more categories of objects that are included in the image is accessed. In operation 404, a first machine learning model is trained, using the dataset, to be able to generate an object mask that identifies each instance of an object for a given object category in a given image, where the training is performed for a plurality of different target object categories. Operation 404 may be performed in accordance with the method 100 of FIG. 1 and/or the method 200 of FIG. 2.

In operation 406, a plurality of given images are processed by the (trained) first machine learning model to generate a plurality of object masks for the plurality of given images. In operation 408, a second machine learning model is trained to perform semantic segmentation using the plurality of object masks and the plurality of given images. The second machine learning model may then be output (e.g. deployed, etc.) for use in perform semantic segmentation for given images.

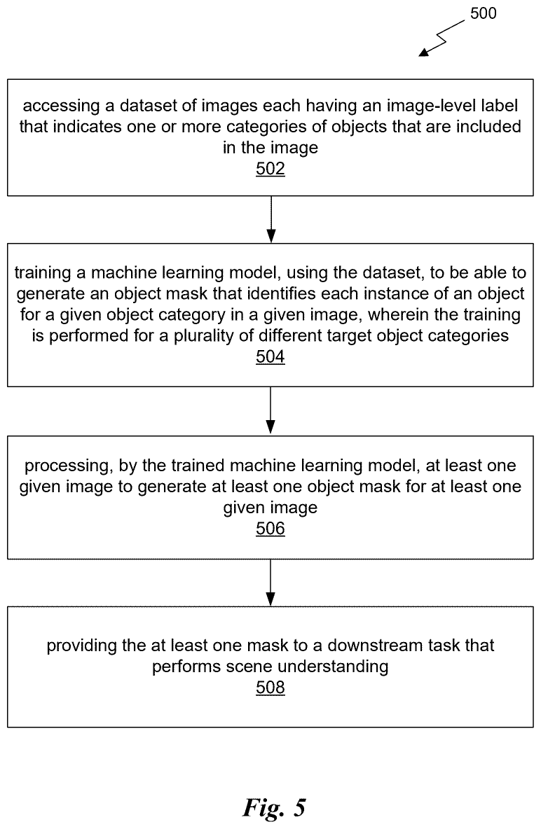

FIG. 5 illustrates a method 500 for generating an object mask for a downstream task, in accordance with an embodiment.

In operation 502, a dataset of images each having an image-level label that indicates one or more categories of objects that are included in the image is accessed. In operation 504, a machine learning model is trained, using the dataset, to be able to generate an object mask that identifies each instance of an object for a given object category in a given image, where the training is performed for a plurality of different target object categories. Operation 504 may be performed in accordance with the method 100 of FIG. 1 and/or the method 200 of FIG. 2.

In operation 506, at least one given image is processed by the (trained) machine learning model to generate at least one object mask for the at least one given image. In operation 508, the at least one mask is provided to a downstream task that performs scene understanding. The downstream task may include, for example, visual captioning, video understanding, visual question answering, etc.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

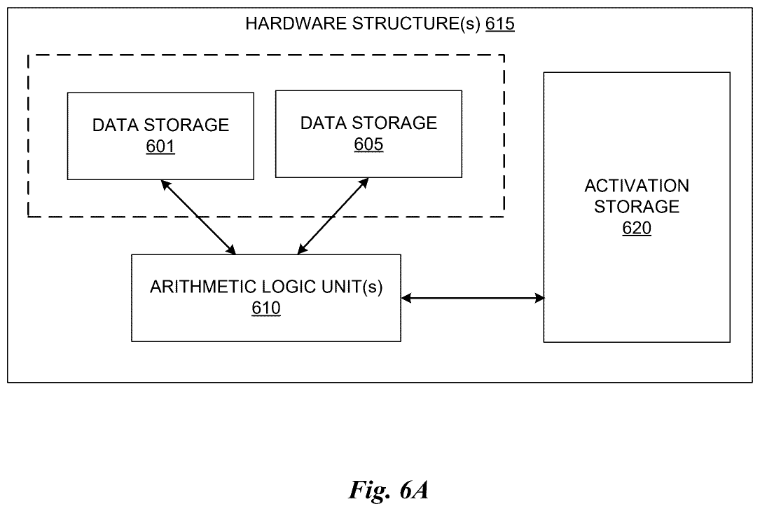

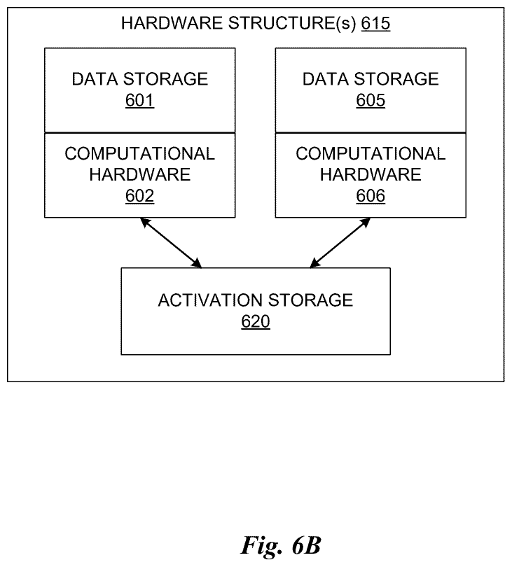

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 are used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### NEURAL NETWORK TRAINING AND DEPLOYMENT

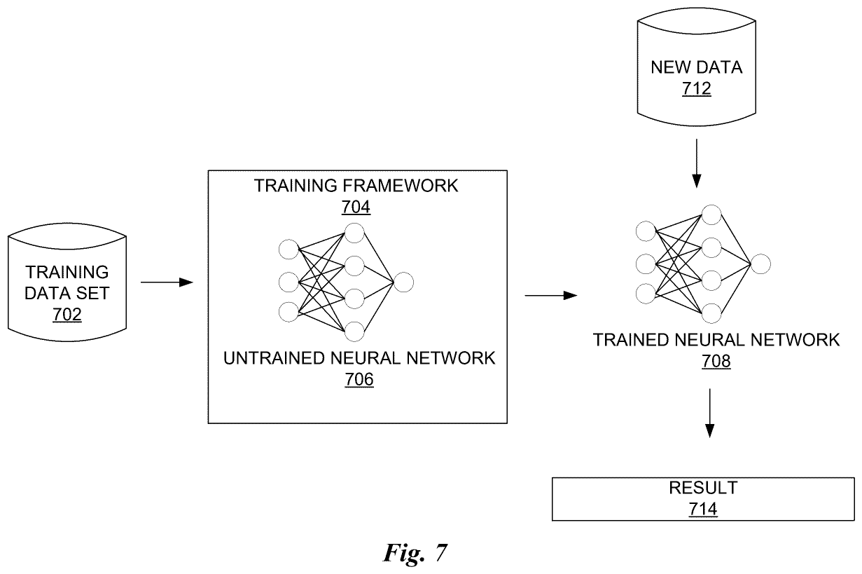

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

### Data Center

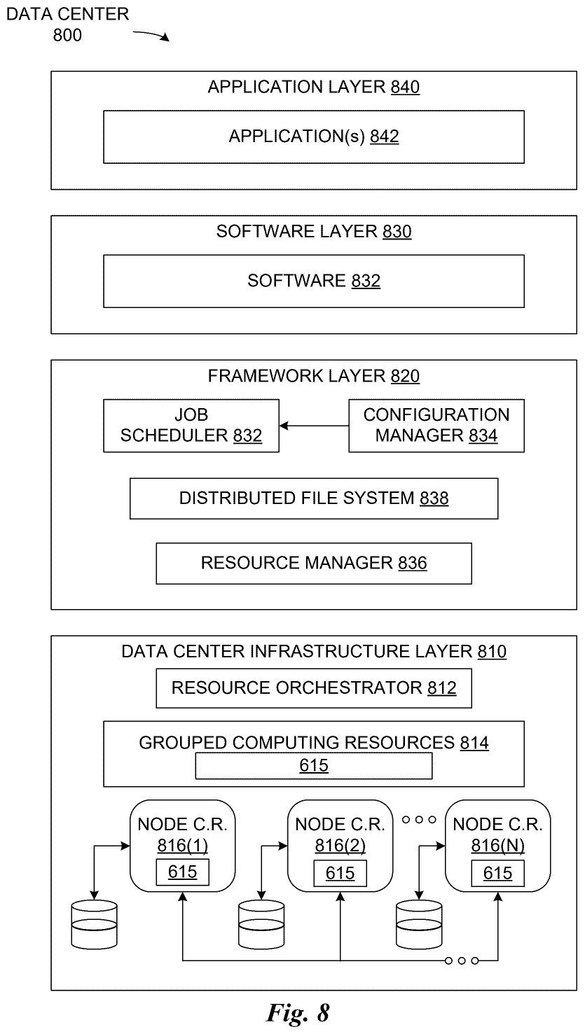

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 822 may configure or otherwise control one or more node C.R.s 816(1)-816(N) and/or grouped computing resources 814. In at least one embodiment, resource orchestrator 822 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 832, a configuration manager 834, a resource manager 836 and a distributed file system 838. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820 including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. In at least one embodiment, resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

As described herein with reference to FIGS. 1-5, a method, computer readable medium, and system are disclosed for training a machine learning model to generate an object mask for a given image. The machine learning model may be stored (partially or wholly) in one or both of data storage 601 and 605 in inference and/or training logic 615 as depicted in FIGS. 6A and 6B. Training and deployment of the machine learning model may be performed as depicted in FIG. 7 and described herein. Distribution of the machine learning model may be performed using one or more servers in a data center 800 as depicted in FIG. 8 and described herein.

What is claimed is:

1. A method, comprising:
at a device:
accessing a dataset of images each having an image-level label that indicates one or more categories of objects that are included in the image;
training a first machine learning model, using the dataset, to be able to generate an object mask that identifies each instance of an object for a given object category in a given image having an image-level label, wherein the training is performed for a plurality of different target object categories including for each target object category:
processing an image having an image-level label that indicates the target object category to generate a text prompt that indicates the target object category,
performing, by the first machine learning model, prompt contrastive learning using a foreground portion of the image, a background portion of the image, and the text prompt, to learn, for the target object category, a prompt embedded with semantic knowledge describing a background associated with the target object category, and
learning, by the first machine learning model from the prompt, to generate a foreground object mask for the target object category;
processing, by the trained first machine learning model, a plurality of given images having image-level labels to generate a plurality of object masks for the plurality of given images;
training a second machine learning model to perform semantic segmentation using the plurality of object masks and the plurality of given images having image-level labels,
wherein the second machine learning model is usable by an autonomous driving application for classifying and locating one or more objects in an environment of an autonomous driving vehicle.

2. The method of claim 1, wherein the processing of the image further includes:
using the machine learning model to predict from the image an unrefined object mask for the target object category.

3. The method of claim 2, wherein the machine learning model uses image-text contrastive learning to predict from the image the unrefined object mask for the target object category.

4. The method of claim 3, wherein the image-text contrastive learning includes:
computing from the image an initial object mask for the target object category,
determining an initial foreground portion of the image based on the initial object mask,
determining an initial background portion of the image based on the initial object mask,
maximizing a similarity between the initial foreground portion of the image and the text prompt, and
minimizing a similarity between the initial background portion of the image and the text prompt.

5. The method of claim 2, wherein the foreground portion of the image is generated by applying the unrefined object mask to the image.

6. The method of claim 2, wherein the background portion of the image is generated by applying a reverse of the unrefined object mask to the image.

7. The method of claim 1, wherein the prompt contrastive learning for the target object category includes:
computing an initial prompt,
determining a representation of the initial prompt in latent space,
determining a representation of the background portion of the image in the latent space,
determining a representation of the text prompt in the latent space,
maximizing a similarity between the representation of the initial prompt and the representation of the background portion of the image, and
minimizing a similarity between the representation of the initial prompt and the representation of the text prompt.

8. The method of claim 1, wherein the prompt represents co-occurring backgrounds for the target object category.

9. The method of claim 1, wherein the machine learning model learns to generate the foreground object mask by excluding semantic knowledge embedded in the prompt.

10. The method of claim 1, wherein the foreground object mask is a mask of an object in the target object category that is included in an image foreground, and wherein the foreground object mask indicates a location of the object in the image foreground.

11. A method, comprising:
at a device, training a machine learning model to generate an object mask for a given image by:
processing an input image having an image-level label that indicates one or more categories of objects included in the image to generate a text prompt that indicates a target object category of an object included in the image;
performing, by the machine learning model, prompt contrastive learning using a foreground portion of the image, a background portion of the image, and the text prompt, to learn, for the target object category, a prompt embedded with semantic knowledge describing a background associated with the target object category; and
learning, by the machine learning model from the prompt, to generate a foreground object mask for the target object category.

12. The method of claim 11, wherein the image-level label is a vector indicating a presence in the image of a plurality of object categories.

13. The method of claim 11, wherein the processing of the input image further includes:
using the machine learning model to predict from the image an unrefined object mask for the target object category.

14. The method of claim 13, wherein the machine learning model uses image-text contrastive learning to predict from the image the unrefined object mask for the target object category.

15. The method of claim 14, wherein the image-text contrastive learning includes:
computing from the image an initial object mask for the target object category,
determining an initial foreground portion of the image based on the initial object mask,
determining an initial background portion of the image based on the initial object mask,
maximizing a similarity between the initial foreground portion of the image and the text prompt, and
minimizing a similarity between the initial background portion of the image and the text prompt.

16. The method of claim 13, wherein the foreground portion of the image is generated by applying the unrefined object mask to the image.

17. The method of claim 13, wherein the background portion of the image is generated by applying a reverse of the unrefined object mask to the image.

18. The method of claim 11, wherein the machine learning model is a vision-language model.

19. The method of claim 11, wherein the text prompt is generated by inserting a name of the target object category into a text prompt template.

20. The method of claim 11, wherein the prompt contrastive learning for the target object category includes:
computing an initial prompt,
determining a representation of the initial prompt in latent space,
determining a representation of the background portion of the image in the latent space, determining a representation of the text prompt in the latent space,
maximizing a similarity between the representation of the initial prompt and the representation of the background portion of the image, and
minimizing a similarity between the representation of the initial prompt and the representation of the text prompt.

21. The method of claim 20, wherein the initial prompt is pseudo-random.

22. The method of claim 11, wherein the prompt represents co-occurring backgrounds for the target object category.

23. The method of claim 11, wherein the machine learning model learns to generate the foreground object mask by excluding semantic knowledge embedded in the prompt.

24. The method of claim 11, wherein the foreground object mask is a mask of an object in the target object category that is included in an image foreground.

25. The method of claim 24, wherein the foreground object mask indicates a location of the object in the image foreground.

26. The method of claim 11, wherein the machine learning model is trained with respect to a plurality of different target object categories.

27. The method of claim 11, further comprising, at the device:
outputting the trained machine learning model for use in generating the object mask for the given image.

28. The method of claim 11, further comprising, at the device:
using the trained machine learning model to generate at least one object mask for at least one given image.

29. The method of claim 28, further comprising, at the device:
providing the at least one object mask to a downstream task.

30. The method of claim 29, wherein the downstream task includes training a semantic segmentation model using a training dataset that includes the at least one object mask and the at least one given image have an image-level label.

31. The method of claim 29, wherein the downstream task includes performing scene understanding.

32. The method of claim 29, wherein the downstream task includes visual captioning.

33. The method of claim 29, wherein the downstream task includes video understanding.

34. The method of claim 29, wherein the downstream task includes visual question answering.

35. A system, comprising:
a non-transitory memory storage comprising instructions; and
one or more processors in communication with the memory, wherein the one or more processors execute the instructions to train a machine learning model to generate an object mask for a given image by:
processing an input image having an image-level label that indicates one or more categories of objects included in the image to generate a text prompt that indicates a target object category of an object included in the image;
performing, by the machine learning model, prompt contrastive learning using a foreground portion of the image, a background portion of the image, and the text prompt, to learn, for the target object category, a prompt embedded with semantic knowledge describing a background associated with the target object category; and
learning, by the machine learning model from the prompt, to generate a foreground object mask for the target object category.

36. The system of claim 35, wherein the one or more processors further execute the instructions to:
use the trained machine learning model to generate at least one object mask for at least one given image.

37. The system of claim 36, wherein the one or more processors further execute the instructions to:
provide the at least one object mask to a downstream task.

38. The system of claim 37, wherein the downstream task includes training a semantic segmentation model using a training dataset that includes the at least one object mask and the at least one given image have an image-level label.

39. A non-transitory computer-readable media storing computer instructions which when executed by one or more processors of a device cause the device to train a machine learning model to generate an object mask for a given image by:
processing an input image having an image-level label that indicates one or more categories of objects included in the image to generate a text prompt that indicates a target object category of an object included in the image;
performing, by the machine learning model, prompt contrastive learning using a foreground portion of the image, a background portion of the image, and the text prompt, to learn, for the target object category, a prompt embedded with semantic knowledge describing a background associated with the target object category; and
learning, by the machine learning model from the prompt, to generate a foreground object mask for the target object category.

40. The non-transitory computer-readable media of claim 39, wherein the one or more processors further cause the device to:
use the trained machine learning model to generate at least one object mask for at least one given image.

41. The non-transitory computer-readable media of claim 40, wherein the one or more processors further cause the device to:
provide the at least one object mask to a downstream task.

42. The non-transitory computer-readable media of claim 41, wherein the downstream task includes training a semantic segmentation model using a training dataset that includes the at least one object mask and the at least one given image have an image-level label.
